(19) United States
(12) Patent Application Publication
(10) Pub. No.: US 2004/0078314 A1
(43) Pub. Date: Apr. 22, 2004

(54) Method and system for offering securities based in entertainment concepts

(76) Inventors: Robert Maerz, Stone Harbor, NJ (US); Ernest Sjo, Huntington Beach, CA (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 10/619,510

(22) Filed: Jul. 16, 2003

Related U.S. Application Data
(63) Continuation-in-part of application No. 09/813,808, filed on Mar. 22, 2001.
(60) Provisional application No. 60/224,351, filed on Aug. 11, 2000.

(51) Int. Cl. G06F 17/60

(52) U.S. Cl. 705/36

(57) ABSTRACT

The present invention relates generally to a system for simulated securities exchange wherein the securities comprise various entertainment industry concepts, such as television show scripts, scripts with talent attached, treatments, pilots, and video games in assorted stages of development. This invention relates more specifically to the establishment of an investment portfolio comprising one or more Pilot Option Participation Securities (POPS) or other entertainment creation securities. Such investment portfolios comprising one or more POPS may, for example, be prepared for listed and listed on a national exchange such as, for example, CBOE, AMEX, NASDAQ, foreign exchanges or bulletin board exchanges (BBX).

### CROSS REFERENCE TO RELATED APPLICATIONS

The present application is a continuation-in-part and claims the benefit, under 35 U.S.C. § 120, of U.S. patent application Ser. No. 09/813,808, filed 22 Mar. 2001, and claims the benefit, under 35 U.S.C. § 119, of U.S. Provisional Patent Application Serial No. 60/224,351, filed 11 Aug. 2000, which are expressly incorporated fully herein by reference.

### FIELD OF INVENTION

The present invention relates generally to a system for securities exchange and simulated securities exchange in which the securities comprise various entertainment industry concepts, such as television show scripts, scripts with talent attached, treatments, pilots, and video games, all in various stages of development. This invention relates more specifically to the establishment of an investment portfolio comprising one or more Pilot Option Participation Securities (POPS). Specifically, this invention can relate to an investment portfolio that will be prepared for listing and listed on a national exchange such as, for example, CBOE, AMEX, NASDAQ, foreign exchanges or bulletin board exchanges (BBX).

### BACKGROUND OF THE INVENTION

Development of non-interactive entertainment creations such as television programming in the United States can occur in two ways. The first way involves a story idea attached to no specific talent. Television production companies and television producers either develop story ideas internally or acquire story ideas from other parties. Producers then approach networks (with whom producers may or may not have extant development deals) with these story ideas. A network, in turn, may pay a fee for the production company to produce a treatment of a particular story idea; such a treatment may undergo numerous rewrites before the producer and the network agree on the treatment's content.

After the network approves the final rewrite, the production company commences casting for the pilot and hires crew members and other personnel needed for production. Following production of a pilot, network executives and test audiences determine whether a network shall air a pilot. If a pilot gets “picked up” (“broadcaster commitment”), networks typically order between six and thirteen more episodes based upon the pilot. In recent years networks have taken a more conservative attitude and starting ordering fewer episodes upfront. This makes it even tougher for shows to get going because there are fewer episodes and a quicker cancellation policy.

Alternately, the second way involves a project having talent but no attached story idea. A production company presents the project to networks. If interested, a network typically provides funds, as outlined above, to the production company to write a script for a pilot catered to the talent strengths. After the production company writes the script, the network decides whether to order the pilot. If the pilot gets “picked up,” a network orders additional episodes based upon the pilot.

Either way, if the pilot eventually becomes an episodic show, deficits absorbed by networks and production companies can increase to amounts in excess of $3 million per season due to common episodic costs such as script-writing costs and various production costs. Production companies typically overcome these deficits by either charging a network an increased licensing fee once a show or movie is successful and/or by entering a show into syndication. Networks, on the other hand, decrease their deficits by revenues obtained from advertising originating from pilots that are aired and from series of episodes that are aired. Although this aspect of the industry is beginning to change and networks are assessing the advantages associated with ownership of television shows and movies produced by network-owned production companies, networks continue to spend astronomical amounts of money each year funding production and script writing costs of pilots that will never undergo broadcast.

The major entertainment companies spend an estimated $10 billion annually for the development, production and distribution of film and television programming. This $10 billion does not include capital for development of programming that is expended by independent writers and creators who are not affiliated with the major studios and networks. The total amount expended by all parties in development and production exceeds $25 billion annually.

In addition, each network/studio typically orders an average of 50 pilots per year. Of these pilots, possibly three to five will be ordered for episodic broadcast and perhaps one show will survive the first year and be re-ordered for a second season. In a specific example, one network in 1996 received over 500 treatments or presentations for sitcom ideas. Of these 500 treatments, around 40 were given money to develop a script. Of the 40 that developed a script, around fifteen were given approval to produce a pilot. Of these fifteen pilots, five received commitments for producing episodes for airing in the fall schedule. In subsequent years, this same network ordered approximately thirty pilots (including sitcoms and dramas) and of these thirty pilots, nine received episodic commitments. The sum of $28 million was spent on these pilots, exclusive of the money spent on the treatments and scripts that never received orders for pilots. These shows incurred production costs of $28 million as well as an estimated deficit of $9 million that was ultimately funded by actual production companies. This particular process is duplicated by each studio/network in a similar manner each year, resulting in excessive amounts of wasted capital as well as a decreased probability (barely one percent) of a particular script/treatment/pilot actually being aired.

Complicating the problem with programming costs today is the national television rating system. Typically, a show must maintain a fairly high degree of national viewership in order to avoid cancellation. This viewership is calculated by rating points, with each point being the equivalent of approximately one million households. Although the goal of networks and production companies is to produce ratings characteristic of shows such as “ER” or “Seinfeld,” the reality is that most new shows sustain barely enough viewership to ensure renewal. In some cases this rating may be as low as one to five percent. Ultimately, networks and production companies hope that a new show is a hit and will financially sustain itself for years.

Further, major television networks have controlled the type of content that was broadcast to American audiences. The only role these audiences have played in controlling content is a role of being mere numbers in a television ratings system. Therefore, networks have, in a thoroughly haphazard manner, spent exorbitant amounts of capital endeavoring to create the next big hit.

Accordingly, a need exists for the efficient management of programming development and the facilitation of program commitments from the entertainment industry, particularly from television networks.

Presently, independent contractors are forced to navigate a myriad of avenues in Hollywood to try to find appropriate individuals within the studio system who will make a commitment to develop their television concepts. Some independent contractors, once they are established, are able to arrange for deals with networks or studios termed “output” or “first-look.” So established, an independent contractor will generate story concepts or treatments for a network's or a studio's consideration.

A network/studio typically has a certain length of time from submission of a project by an independent contractor to decide whether to develop the project and to provide necessary funding for the project. Even if a project is ordered for development, the pilot production stage can take years to reach; further, there is no guarantee that the concept will reach this stage. Further, during this ongoing procedure, the public is not solicited for its input; instead, writers and other creative personnel engage in a haphazard “guessing game” as to what may be accepted by viewing audiences.

For the majority of independent contractors who are less fortunate and who do not have a formal relationship with a studio/network, the task of getting their concepts accepted is even more difficult. Aside from traditional “pitching” of his ideas to anyone who will listen, an independent contractor normally must seek an agent who will represent him. If one is successful in retaining an agent, the agent will attempt to get the “right people” to read the concept or treatment and to receive approval of the concept or treatment. Even after attracting interest, a writer/creator may be asked to re-write a particular concept numerous times before it will be presented to creative content personnel for consideration.

Today, the television industry is undergoing rapid change. No longer indifferent toward future rights, most (if not all) of the major networks are insisting upon partial or total ownership of all the shows that they air. Previously, the FCC had prohibited producers from controlling the distribution outlets under the “consent decree;” today, this FCC prohibition has been partially overturned. The FCC now prohibits a company from owning stations that reach more than 35% of the country, but faces mounting pressure to allow companies to own stations that reach 50% of the country.

Large studios such as Disney and Viacom have purchased ABC, CBS, and more recently, upstart UPN. Internet service provider AOL has recently merged with Time Warner, and this merger will provide these companies with continued and ongoing ownership of programming in the future. Most recently, the French Corporation Vivendi has purchased Universal Studios. Universal, it should be noted, already owns 45% of Barry Dillers' USA Network. NBC has purchased a one-third (⅓) interest in PAXNET. This massive consolidation in the entertainment industry is likely to continue.

One consequence of this consolidation is that it will now be more difficult than ever for an independent producer to receive consideration for his ideas by the networks. It is an underlying assumption that the networks will show preference in airing programming that has been developed “in house” by their own studios. As the competition becomes more acute for attracting viewers, and with ever-increasing channel capabilities, the capital that must continually be allocated for the development and production of programming will continue to increase in amount.

Another consequence that will arise as a result of this ongoing consolidation of networks and studios is a decrease in the amount of money provided to affiliates by networks. Affiliates are independent broadcasters, commonly referred to as television stations, that exist in every market from Maine to California. Historically, networks have created a presence throughout the U.S. by “stringing together” affiliates and by annually providing large sums of money to these affiliates to carry network programming. This method has traditionally been the one by which networks build an identity on a local level. It is estimated that networks such as ABC, NBC, and CBS each pay between $150 and $200 million annually to their affiliates. However, with ongoing consolidation, networks are beginning to phase out these payments and it is expected that these payments will be totally eliminated within 5 to 10 years.

As a result of this trend, affiliates will be forced to pay large sums of money to receive network programming or will be forced to seek alternative forms of content. As the competition becomes more acute for attracting viewers, and with ever-increasing channel capabilities, the need for capital that must continually be allocated for the development and production of programming will continue to grow. POPS can help alleviate this anticipated problem by helping affiliates finance programming for local viewers.

Similarly, interactive entertainment creations such as video games have traditionally been developed and marketed in an expensive and excessively risky fashion. Meanwhile the video game market is undergoing considerable expansion, particularly in the area of on-line gaming. Video game developers have traditionally relied on a number of techniques for obtain creative ideas for products. For example, early game designers created fairly abstracted games based on everyday forms of entertainment such as ping-pong. As game design progressed, success was dependent more on playability than on typical creative concepts such as plot or theme. Today, an increasing area in game design revolves around building highly intricate plots or themes on an established gaming engine. Thus, the design typically involves considerations both of playability vis-á-vis the game engine, and creative concepts vis-á-vis the plots or themes.

In a typical game development cycle, the game may be developed to a large extent within a software developing house. This company typically will invest in a particular gaming concept that may include a previously developed game engine. Significant work will be done before anyone besides the game developers see the game. When the game is playable, the game is usually submitted in alpha form to in-house testing personnel. Once the alpha-testers report bugs or other issues to the game developers, a beta version of the game is usually released on a limited basis to a number of people outside the company. These beta-testers perform a similar function to the alpha testers but also permit some word of the game's quality to be compellingly conveyed to the gaming community.

One danger of the traditional game development cycle, however, is that a significant amount of product development and thus investment in the entertainment creation occurs prior to an opportunity to observe a market reaction to the creation. Thus, a need exists for a system or method that can provide an accurate market reaction earlier in the development cycle.

Video games are a broad area of interactive entertainment. Video games are presently produced in such genre categories as action, adventure, arcade, puzzle, racing, role-playing games (RPG), real-time strategy shooters (RTSS), simulation, and sports. Video games may also be categorized by the type of interactivity of the user or player. These interactivity categories may include first person perspective, third person perspective, and scenario perspective. Video games may also be categorized by the number of players. For example, video games include single player games, as well as two player games, multi-player games and massively multiplayer games.

### SUMMARY OF THE INVENTION

The use of an entertainment securities trading forum, through a website, can premiere concepts and potential talent in an early polling process. This polling can solicit the opinions of audiences and allow independent producers and participants to gauge, rather than guess—what audiences are looking for in television or other entertainment. In addition, by grouping television or other entertainment concepts or creations into a portfolio such as the entertainment securities basket or POPS basket and allowing the investing, viewing, and gaming public to provide investment capital, an entertainment securities trading forum can play a major role in the process of funding programs games or other entertainment creations and obtaining episodic commitments from networks.

There may be many potential developers, end broadcasters or licensors of entertainment creations. In particular, with regard to video games the end licensors may include such companies as Sony, Microsoft, Electronic Arts, Alliance Corp., Sega, or Activision. Other end licensors may include broadband distribution companies such as Movielink and Real Networks. Additionally, certain companies that primarily provide other products or services may wish to be end licensors. Such companies may include, for example, hotels, restaurants, or airlines.

An object of the present invention is to provide a method and means for networks and production companies to ease the financial burden associated with pilot production by minimizing the amount of money that must be invested up-front by networks and production companies before a pilot airs on television. This object is accomplished by establishing a product for investment in television concepts and ideas, prior to these concepts or ideas being aired on television. This product utilizes a computerized Internet-based system.

Yet another object of the present invention is to minimize the number of script rewrites required before a network approves a script by utilization of a computerized polling process executed over the Internet which enables potential investors to view television pilot treatments and scripts before the treatments and scripts become pilots. This polling process provides valuable input information to networks while simultaneously decreasing the amount of money spent paying writers to write and rewrite scripts.

A further object of the present invention is to provide a forum whereby television pilot ideas can be fine-tuned and revised on the Internet via a polling system whereby solicitation of television audiences early in the pilot treatment process results in more timely and appealing television programs.

Another object of the present invention is to provide a means of creating, producing, and funding television programming for a worldwide audience with the use of a personal computer and the Internet.

Yet another object of the present invention is to provide a liquid trading market for television treatments and pilots. Such treatments and pilots are currently illiquid investments.

An object of the present invention relates to a method and system for establishing a product for investment in pilots for television shows and movies, the method comprising grouping the pilots into a portfolio and offering the portfolio for investment wherein the method and system groups a plurality of pilots, assigns a rating to a pilot, groups the pilots based on a rating value, and brands the portfolio of pilots.

Another object of the present invention involves a method and system for establishing a product for investment in pilots for television shows and movies, the method comprising grouping the pilots into a portfolio and offering the portfolio for investment wherein the method and system assigns a rating to a pilot and wherein the rating value is based on whether a network has ordered the pilot.

An additional object of the present invention relates to a method and system for establishing a product for investment in pilots for television shows and movies, the method comprising grouping the pilots into a portfolio and offering the portfolio for investment wherein the method and system comprises reporting an investment history of the portfolio and wherein the investment history is reported over the Internet by use of a computer to display investment data and further comprises reporting the investment history by use of a telephone to relay investment data.

A further object of the present invention involves a method and system for establishing a product for investment in pilots for television shows and movies, the method comprising grouping the pilots into a portfolio and offering the portfolio for investment wherein the method and system assigns a rating to a pilot and wherein rating the pilot further comprises providing a script-talent listing and a script-talent rating based on a percentage of times a script-talent is listed.

Another object of the present invention relates to a method and system for establishing a product for investment in pilots for television shows and movies, the method comprising grouping the pilots into a portfolio and offering the portfolio for investment wherein the method and system assigns a rating to a pilot and wherein rating the pilot further comprises conducting a survey of the pilot over the Internet to determine a trade volume based on an eight hour trade day and wherein conducting a survey for the pilot further comprises determining a production rating and designating the production rating with a value when a script matures to become one of the pilots and wherein the survey is conducted by use of a computer to manipulate trade volume data or by use of a telephone to relay trade volume data and wherein conducting a survey for the pilot further comprises determining an initial day's rating for the pilot and wherein the step of determining an initial day's rating is based on the first twenty-one days that a pilot is grouped into a portfolio.

Another objective of the present invention relates to a method and system for establishing a product for investment in pilots for television shows and movies, the method and system comprising grouping the pilots into a portfolio and offering the portfolio for investment and wherein the method and system assigns a rating to a pilot and wherein rating a pilot further comprises conducting a mock trading procedure over the Internet for the pilot and wherein conducting a mock trading procedure generates a rating based on a number of times the pilot is traded.

Another objective of the present invention concerns a method and system for establishing a product for investment in pilots for television shows and movies, the method comprising grouping the pilots into a portfolio and offering the portfolio for investment and wherein the method and system assigns a rating to a pilot and calculates the pilot ratings by use of a computer and the method and system further comprising calculating the pilot ratings by aggregating a database of rating inputs and accessing the database of rating inputs via the Internet.

An object of the present invention is to provide a method and means for software development companies to ease the financial burden associated with software development by minimizing the amount of money that must be invested up-front before a demo or beta-version is released. This object is accomplished by establishing a product for investment in entertainment creations, prior to these creations being publicly released. This product may utilize a computerized Internet-based system.

A further object of the present invention is to provide a forum whereby entertainment creation ideas can be fine-tuned and revised on the Internet via a polling system whereby solicitation of viewing or gaming audiences early in the development process results in more timely and appealing entertainment creations.

Another object of the present invention is to provide a means of creating, producing, and funding entertainment creations for global distribution with the use of a personal computer and the Internet.

Yet another object of the present invention is to provide a liquid trading market for entertainment creations in the early stages of their development. Such entertainment creations are currently illiquid investments.

### BRIEF DESCRIPTION OF THE DRAWINGS

FIG. 1 is a flow diagram of the POPS host computer system represented by the use of Microsoft Windows 2000 Operating System (server edition) in conjunction with the Microsoft Internet Information Server (IIs) and Microsoft SQL Server 7.

FIG. 2 is a flow diagram of the current POPS client interface.

FIG. 3 is a flow diagram representing the overall organization of the POPS system.

### DETAILED DESCRIPTION

Known methods of investing in securities and/or purchasing items by computer include the distribution and/or implementation of investment portfolios by computer software and/or via the Internet, distribution of buy and sell orders in the form of derivative financial instruments via server and client computers, the utilization of the Internet to place orders for items that purchasers select from an electronic catalogue and add to an electronic “shopping cart,” and the generation, sale, and purchase of online airline tickets via computers connected by a network such as the Internet.

By contrast, POPS or other entertainment securities are securities that can combine aspects of the entertainment business with the excitement of Wall Street. They can include a security that groups an estimated ten-to-twenty television projects together into what is termed a “POPS basket” that can form one security suitable for investment on a national exchange in which members of the public can invest. In turn, money put into the security by investors can serve as development and production money for independent production companies, individuals, networks, or their affiliates. A POPS may comprise several different entities including a single television script, a script with talent attached, a rewritten script, a rewritten script with talent attached, a treatment, a television pilot, a trailer, or a story bible. POPS can represent any television concept, work, or idea in any stage of development.

Other entertainment securities may include a security that groups multiple entertainment creations together into an entertainment creation basket. Such an entertainment creation basket may form a single security available for public investment on a national exchange. The money invested in the security may serve as development, production, or testing money for the entertainment creation producers such as computer game companies or programmers. The security may represent an entertainment creation at any stage of development.

A POPS basket can be a collection of POPS that are grouped together with respect to certain criteria determined by the decision matrix discussed below. The provision to a script with or without talent of financial backing can commence the pilot production stage and ultimately lead to the creation of a television pilot. The various POPS baskets may include, but are not limited to, including sitcoms, dramas, Movies of the Week, science fiction programs, syndicated shows, and children's shows. The programs that are put into each POPS basket can be initially chosen by various entities including production companies and networks. POPS can accomplish the creation of a liquid trading market for what are presently illiquid investments. The general public can now be included in the creation and development of television programming by interacting with the POPS polling process and decision matrix. In addition, with the mock trading system associated with POPS, the interested public can also trade the POPS security.

An entertainment creation basket may be a collection of entertainment creation securities that are grouped together with respect to certain criteria determined by the Decision Matrix discussed below. The various entertainment creation baskets may include but are not limited to including action, adventure, arcade, puzzle, racing, RPGs, RTSSs, simulation, sports, first person perspective, third person perspective, scenario perspective, single player, two player, multi-player, and massively multiplayer video games. The programs that are put into each entertainment creation basket can be initially chosen by various entities including production companies, programmers, or programmer groups. Entertainment creation securities can accomplish the creation of a liquid trading market for what are presently illiquid investments. The general public can now be included in the process of creation and development of video games by interacting with the entertainment creation polling process and decision matrix. In addition, with the mock trading system associated with entertainment creation security, the interested public can also trade the entertainment creation security.

A “treatment” can be defined as a rough idea that has not been provided with funding adequate to transform the idea into a script.

A “script/talent listing” on the POPS system can encompass a title and brief description, that also may include, for example, graphic images, clips, and trailers, which may be used to enable a user of the POPS system to identify the specific script/pilot. A script/talent sample may be defined as a time slice of Web server hits of a singular script/talent listing.

An “individual listing served” can be defined as the number of times a user of the POPS system requests a certain listing. Each occasion within which both a user requests a specific script/talent listing section of a web page and the web server returns that section to the Client Browser can be counted by the system.

### Entertainment Creation Securities Host Computer System

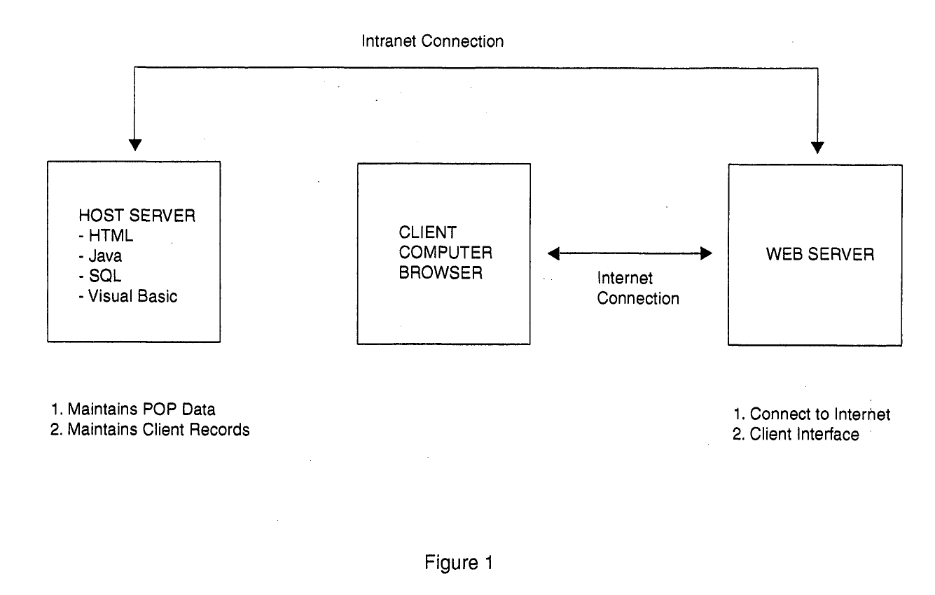

The entertainment creation securities (for example, POPS) host computer system FIG. 1 is represented by the use of the Microsoft Windows 2000 Operating System (server edition) in conjunction with the Microsoft Internet Information Server (IIs) and Microsoft SQL Server 7. The Microsoft Internet Information Server interfaces to the Internet via TCP/IP and the HTTP Protocol while simultaneously interfacing with the Database Server Microsoft SQL Server 7. Other operating systems such as UNIX or LINUX may be used, as may other server software, such as Apache.

### Decision Matrix/Rating Algorithm/Simulated Exchange

CLIENT #1—Reflects the public.

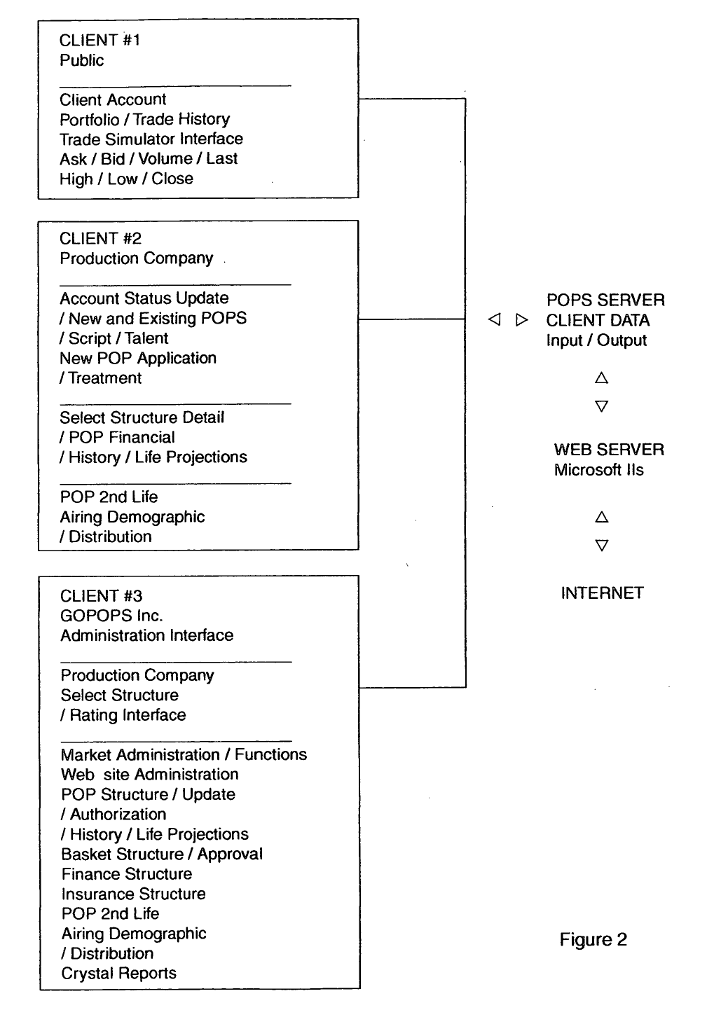

Client #1 FIG. 2 represents a client browser with an entertainment creation security trading interface in this scheme. The client account involves POPS or entertainment creation securities as well as POPS or entertainment creation security baskets, trade history of particular POPS and POPS baskets (or entertainment creation securities or entertainment creation security baskets), a trade simulator interface, information related to the asking price, bidding history, trade volume, and last price, as well as the high, low, and closing prices.

CLIENT #2—Reflects a production company

Client #2 FIG. 2 represents a client browser with a custom designed Web Interface for a TV Pilot production company. “Account Status Update” reveals the production company, any new or existing POPS related to that production company, script talent listings, treatments, as well as new POP applications. “Select Structure Detail” provides status on a POP including financial data, POP history, POP life projections including POP 2nd Life (which relates to a pilot has aired so that the option ceases to exist), airing/demographic information, and network distribution.

CLIENT #3—Reflects the POPS website.

Client #3 FIG. 2 represents a client browser interface with remote administration of the POPS host server, Microsoft Internet Information Server and SQL Server 7. The Administration Interface holds the current list of production companies. Select Structure refers to all customization of a client interface. Marketing/Administrative functions fall under the category of website administration. POP Structure/Update refers to both steps and information that are critical in the process of creating a POPS basket including Authorization, POP History, POP Life Projections, Basket Structure/Approval, Finance Structure, Insurance Structure, POP 2nd Life, Airing Demographic, Distribution, and Crystal Reports.

### Pops Organizational Flow Chart

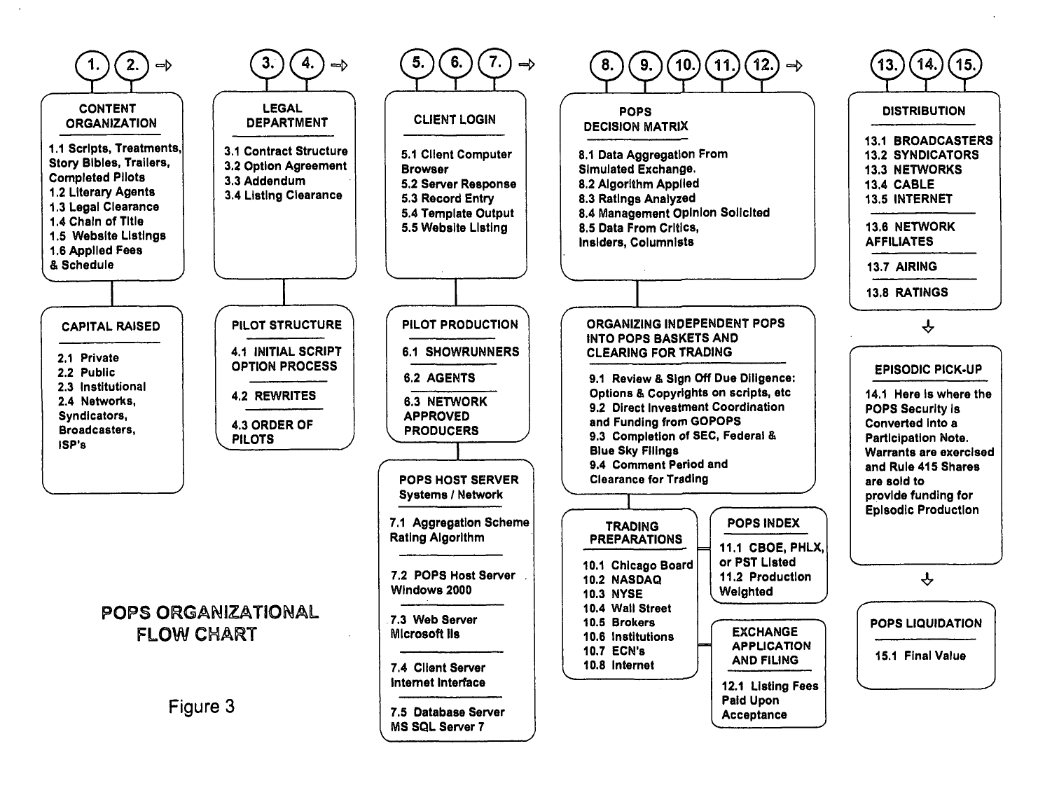

In FIG. 3, the initial content organization 1 of each POP may comprise scripts, treatments, completed production company pilots, writers, agents or showrunners. Also, any literary agents utilized, as well as the status of legal clearance, may be associated with each POP. Further, scripts and fees are submitted and a Chain of Title for Copyright is provided for each script. Finally, a website listing transforms the script or work into an actual POP.

The capital raised for projects 2 may comprise monies from private or public organizations, institutions, networks, syndicators, broadcasters, or Internet providers.

The legal department 3 may be responsible for contract structure, as well as, approval of any agreements made, option agreements, and addendums (if necessary) to party agreements. Further, listing clearances on the POPS Server System are either approved or denied by the legal department 3 for each script, treatment, story bible, trailer or completed pilot.

Pilot structure 4 may be comprised of initial script option processes, rewrites, and the hierarchy of the pilots that may be based on a network's commitment for property.

Client login 5 may comprise the client's computer browser, server response time, record entry, and template output. These all ultimately may lead to a POP website listing. In a theoretical example, Client #2 FIG. 2 (i.e., a production company) logs onto the POPS Server System and requests access to a preapproved account for private use. Subsequently, the POPS Server System generates a client side browser interface in order to provide Client #2 with the ability to modify or update any scripts or works as well as headings or descriptions associated with each script or work that are part of the public viewing portion of the website.

Key players in the pilot production stage 6 may comprise showrunners, which may serve as network contracted production coordinators; agents, who may negotiate details of contract finalization associated with commencement of principle photography, as well as network approved producers.

The POPS host server 7 may provide system/network functions such as the Aggregation Scheme Rating Algorithm, the POPS Host Server provided by the Windows 2000 system, the Web Server Microsoft II's, Client Server Interfaces, and the Database Server Microsoft SQL Server 7.

Next, in the POPS Decision Matrix 8, data from the simulated exchange may be aggregated and algorithms may be applied to this aggregated data for the purpose of producing ratings for each POP. Management or others may further analyze ratings in order to generate opinions.

The POPS Index 11 may monitor the details of the pilot and episodic, television programming industry, both nationally and internationally, in a centralized manner. The POPS Index may provide a foundation for a futures trading market whereby investors may hedge an existing investment, or may attempt to project the future value of a specific POPS or the Index as a whole.

Once a POPS Basket is formulated 9, the pricing of the securities may be determined (for example, this may take place as the Basket is prepared for trading 10). Each individual Basket may contain a specific category of programming, e.g. children, drama, action, sitcom, etc. The budgets of the pilots, as well as an episodic commitment may be ascertained. The overall POPS should be structured to provide funding for the pilot and the anticipated broadcast license agreement of between 6 and 13 episodes. To accommodate funding from pilot stage to completion of the ordered episodes, it is expected that a combination of units (stock and warrants) and Rule 415, shelf registration shares, may be included in the 1933 and 1934 act filings with the Securities and Exchange Commission. Once a pilot has been licensed for additional episodes 14, the option converts to a participation note. Investors may have the right to exercise warrants attached to their initially purchased unit (stock), which may, in turn, provide funds for the production of the episodes within the POPS security. Investment banks may issue tranches of Shelf Registration shares if additional funds are needed. Agreements with Broker/Dealers may be secured prior to inception to facilitate these additional, ongoing offerings.

Web pages can, for example, be defined using Hyper-Text Markup Language (HTML). HTML provides a standard set of tags that define how a web page is to be displayed. When a user commands the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain other web pages available on that server computer system or other server computer systems.

An individual client reaches the POPS website through a standard Internet connection via a web browser such as Internet Explorer® (Microsoft) or Navigator® (Netscape). Web pages viewable without a login password are deemed to be public and are viewable by anyone on the Internet. Sections of web pages on the POPS website that are deemed to be private require a password for the client web browser to display the web pages generated by the POPS host server system. When a client 7.4 accesses the Simulated Exchange section of the client website system, the browser prompts the user to enter a login password and client account name. The POPS host server system receives verification of the client account and identification of the client web browser. The server system then assigns a client identifier to the client and associates the assigned client identifier with the received client account information. The server system sends to the client web browser the assigned client identifier and HTML web pages. The client web browser receives and stores the assigned client identifier and displays the appropriate HTML web pages for simulated trading. The server system 7.2 can then receive trade requests and combine the client account information associated with the client identifier of the client web browser to generate trade and portfolio information.

The POPS website is also a showcase for script and talent listings. When a production company assigns or designates user logs into a secure area of the website, the production company then has the ability to enter, modify, and update script and talent information that is shown on the public website as a script and talent listing. The script and talent listing appears on the public section of the website as soon as the listing is approved and a symbol is assigned for mock trading.

By allowing a plurality of types of production companies and their associated writers/agents to showcase new ideas and modify existing ideas in the form of scripts while simultaneously receiving feedback from the POPS Simulated Exchange aggregated data, the POPS website becomes an important information tool and integral part of the decision process by which a singular pilot (POP) meets criteria and is grouped into a basket (portfolio) for final analysis and approval. Once a basket of POPS has been made into a security suitable for trading on a national exchange, the POPS mock trading symbol is delisted on the POPS Simulated Exchange and the POPS basket is prepared for official trading, on a national exchange, e.g., NASDAQ, AMEX, CBOE.

### Decision Matrix/Rating Algorithm/Simulated Exchange Sequence

Initially, a production company, writer, or agent submits a script or treatment and provides a chain of title for copyright of each script or treatment. Subsequently, a legal staff member determines a contract structure and provides approval on any agreements made between POPS and production company, writer, or agent, or provides supplements such as addendums to the contract if necessary. Legal staff also provides or denies approval for listing scripts, treatments, story bibles, trailers or completed pilots (works) on the POPS Server System.

Client #2 then logs on to the POPS Server System and requests access to a pre-approved account for private use. Next, the POPS Server System generates a client side browser interface. The purpose of this interface is to modify or update as needed the script or work headings/descriptions used in the public viewing portion of the website. At this stage, the script or work is called a POP.

The POPS website includes a simulated stock market (Simulated Exchange) for mock trading of POP symbols individually, or as a symbol that represents a group of pilots (POPS). The POPS Simulated Exchange can serve two purposes, the first being trade data aggregation for use in popularity and demographic analysis and the second being the name recognition saturation of the individual POPS brands prior to actual listing of the securities on a national exchange.

Each POP is rated through a Decision Matrix process by users of the POPS Simulated Exchange. Criteria such as Simulated Exchange Daily Volume, Simulated Exchange Initial Day's Trade Volume, Simulated Exchange Script/Talent, Production, and Simulated Exchange POPS Basket Performance are used to evaluate the various POPS/POPS. These POPS Decision Matrix components are active from the moment the listing is activated on the POPS Server System and are thus listed with a symbol on the POPS Simulated Exchange. Once the POP has been listed for trading and public review, a summarized opinion is solicited from the appropriate management parties.

Rating algorithms 7.1 are then applied to data of the Decision Matrix rating components. A 120-day period is used as a baseline for each listing sample. The initial day's rating is the first 21 days of this period.

### Simulated Exchange Pop Daily Volume Rating

The POP volume rating is applied to a singular POP symbol on the POPS simulated exchange. POP daily trade volume is the sum trade volume for an individual POP in any one trade day. The POP volume rating is the POP daily trade volume percentage of the total volume for all active POPS, where retired pilot volume is excluded.

### Simulated Exchange Pop Initial Days Rating

The Initial Day's Rating is applied to a singular POP symbol, as well as to a POPS basket symbol on the POPS Simulated Exchange. As new POPS are added to the POPS Simulated Exchange, an algorithm is applied to track and compare the initial day's trade volume and script/talent listing polling interest, (i.e., the number of web server hits for a singular script/talent listing). The Initial Day's Rating is the (POP and POPS) trade volume and Script/Talent sample, for the first 21 trade days of the new POP or POPS basket issuance.

### Simulated Exchange Script/Talent Rating

As a pilot script progresses and has talent attached to it, the POPS web site updates and showcases the current listing. All script and talent listing pages served by the Web Server (IIs) is the individual symbol listing total. The Script/Talent Rating is the individual listing percent of the sum total of all listings served.

### Simulated Exchange Pop Production Rating

For each POP that reaches production stage, the production company associated with the pilot is issued an individual pilot point. The production rating is percentage of pilot points accumulated by each production company as compared to the total pilot points accumulated by all production companies combined.

### Simulated Exchange Pops Basket Performance Rating

As a POP reaches the production stage, the POP is added to a pilot group, known as a POPS basket, through the Decision Matrix process. A POPS basket is a group of pilots that are grouped together into one Exchange Traded Security (also termed “portfolio”). Prior to a POPS basket trading on a national exchange, it is mock traded on the POPS Simulated Exchange. The POPS Basket Performance rating is defined as the individual POPS Basket symbol trade volume percentage of the sum total of all POPS basket symbol trade volume.

The POPS Simulated Exchange, script and talent listings, select and custom client interfaces, direct production company feedback and information, POPS life and 2nd life projections, airing and demographics are all part of the overall POPS Decision Matrix. The concept of grouping together television pilots into a tradable security requires a computer system reliant decision process, along with industry experience that defines the core of the POPS Decision Matrix.

The POPS Server System applies a custom algorithm with structured data results for each applicable component of the POPS Decision Matrix after a specific symbol of the POPS Simulated Exchange has been sampled over a finite time period. Each component of the data is analyzed and converted into a rating used to determine the advancement of a POP. A POP has a high probability of being grouped into a POPS basket when its ratings are satisfactory and the managerial components are in alignment or agreement for pilot production. A POP that has already been produced and that has received high ratings has the highest probability of being grouped into a POPS basket.

Once a basket of a number of POPS is created, the group is known as a POPS. A POPS trades as a single symbol on the POPS Simulated Exchange while funding, insurance, and all other legal contracts are finalized. Legal, Accounting, Securities and Exchange Commission (SEC) filing, and Exchange Listing costs—as well as all other applicable fees—are applied to the POPS basket. Funding of the new POPS may be completed by utilizing insurance, trust indentures, completion bonds, annuities, government-backed securities and/or guaranteed investment contracts. Insurance is provided to guarantee the investment principal for each POPS basket.

The security structure of the new POPS basket may resemble a unit investment trust with a terminable life (7 to 10 years) with investors participating in all rights and licensing royalties from the show including its final liquidation value. The POPS is listed on a national exchange and starts trading prior to network airing of any of the pilots contained within the POPS basket. Liquidity is achieved as the POPS baskets are traded. All statistics are formulated for the POPS index. The POPS index option is listed on a major option exchange, such as the Chicago Boards Options Exchange (CBOE).

A stock option is a contract that conveys to its holder the right, but not the obligation, to buy or sell shares of an underlying security at a specified price on or before a given date. After this given date, the option ceases to exist. Options are listed securities that are handled through brokers and are similar to stocks. However, an important difference between options and stocks is that, unlike a share of stock, an option can expire and the number of options is not fixed. Also, stock owners hold a share of the company being invested in, including voting rights and dividends, where option holders do not own a piece of the company and only benefit if the price of the security rises or falls. With the advent of online trading implemented through the Internet, options can be traded anywhere in the world on a personal computer. As they can with options, investors can trade POPS on major exchanges and online.

Opportunities for direct investment in the entertainment industry, apart from POPS, are limited. An interested investor may invest in stocks of the major networks/studios (such as Disney, Viacom, or AOL/Time-Warner) or into motion pictures primarily through limited partnerships. In these types of investments an investor who provides capital for a movie must live with the investment for the duration of the partnership which can be between five and ten years. The partnership may own or participate in certain rights for approximately 1-8 projects. If, for any reason, the investor wishes to liquidate his investment, he is relegated to finding a buyer himself or trying to sell through a limited partnership exchange such as CBOE. In contexts other than contexts involving POPS, it is easy to see how previously illiquid investments have been advantageously provided with liquidity by observing, for example, the market that exists today for trading mortgages (such as, for example, Fannie Mae (FNMA) and Real Estate Mortgage Investment Conduit (REMICS)). Similarly, POPS can bring leverage and liquidity to what are presently illiquid investments.

The initial price of a POPS may be determined by market conditions and the perception of the investing public. Market conditions relate to daily fluctuations in the investment market that can be clustered into specific trends, enabling the prediction of the value of a security. Public perception, in the present invention, relates to a simulated stock market (Simulated Exchange), which is part of the POPS system. The Simulated Exchange allows potential investors to preview—via a mock trading procedure—various television scripts, treatments, or pilots, and to provide their opinion of whether these scripts, treatments, or pilots will receive network commitments for an episodic television show. Thus, this simulated exchange can serve two purposes, the first being trade data aggregation for use in popularity and demographic analysis and the second being the name recognition saturation of individual POPS brands—termed “branding”—prior to the actual listing of the securities on a national exchange.

According to network executives, each network spends in excess of $50 million annually on the creation and development of their new shows; this sum is exclusive of production costs. Each network will on average order nine new shows per year. If the pilots are not picked, the networks can “write off” a large portion of the costs of development. Thus, networks will want provide POPS a percentage of their shows in exchange for development money. Networks, syndicators, cable operators, broadcasters, production companies and Internet Service Providers (ISPs) can choose the projects that can be placed in a POP. Many times, both production companies and networks create sound concepts for television programming but the timing for particular programming may be wrong. Historically, these concepts are shelved and, in most cases, never reemerge for public consideration. With an active trading market or a set trading duration (three to five years), the public can have the opportunity to remember and reconsider these concepts at a future date, providing greater efficiency to the programming process. Naturally, POPS can provide a forum whereby pilot ideas can be fine-tuned and revised on the Internet with the help of the public. Therefore, optimum timing to air a show can be more accurately assessed and the prospective talent attached to a show may be advantageously determined.

With funding potentially available through investment in POPS, POPS will provide a targeting apparatus for creating, producing, and funding television programming to a worldwide audience with the use of the personal computer and the Internet. Consequently, as the creation of popular shows is more efficiently financed, fewer shows will be produced that will ultimately fail. POPS can reduce the risks associated with the existing process of television programming.

With the advent of POPS, independent contractors not associated with major studio/networks can find viable alternative sources of financing for their projects and, simultaneously, local affiliates can reduce their dependence upon large networks. Further, by placing their concepts into a POPS, owners of scripts or concepts can retain partial ownership, receive financing, and may retain increased creative control of their property. Additionally, studios, networks, affiliates, ISPs can also benefit by utilizing POPS as a vessel to receive public financing directly for specific projects.

With the arrival of wide-band capabilities, access to overseas markets from wireless technology and the Internet will increase because the arduous and expensive task of installing cable systems and phone lines will not be necessary. It is estimated that, by 2003 to 2005, 30% of U.S. households will utilize interactive components provided by the Internet in conjunction with household televisions. In addition, as evidenced by the fact that over 50% of U.S. households now own stock, fears previously associated with stock ownership by smaller investors have diminished. Thus, POPS can and will afford smaller investors the opportunity to invest in a determined number of shows early in the process of pilot production. Further, through the Decision Matrix, these same investors can participate in the creative process that develops television shows. By investing in POPS, an investor's money can be allocated among a number of potential shows, thereby minimizing investment risk. Further, if a particular show becomes a hit, the potential can exist for a high rate of return on the investment.

Although the foregoing description discusses the design of an embodiment in terms of television pilots, it should be understood that this description may be readily adapted to provide for other types of entertainment creations. For example, video games in various stages of development may be substituted for scripts or pilots, and video game development organizations may be substituted for production companies and networks. Other entertainment creations to which this invention may be applied include, for example, theatre productions, operas, and movies.

The foregoing description of the preferred embodiment of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description but rather by the claims appended hereto.

What is claimed is:

1. A method for establishing a product for investment in entertainment creations, the method comprising:
grouping entertainment creations in an early stage of development into a portfolio; and
offering said portfolio for investment.

2. The method of claim 1, wherein said step of grouping said entertainment creations into a portfolio further comprises combining a plurality of entertainment creations.

3. The method of claim 1, further comprising assigning a rating to an entertainment creation.

4. The method of claim 1, wherein said step of grouping said entertainment creations into a portfolio is based on a rating value.

5. The method of claim 4, wherein said rating value is based on whether a development organization has made a final decision as to whether to continue the development of said entertainment creations.

6. The method of claim 4, wherein said rating value is based on an initial evaluation of the entertainment creation.

7. The method of claim 1, further comprising reporting an investment history of said portfolio.

8. The method of claim 7, wherein said investment history is reported over the Internet.

9. The method of claim 7, further comprising reporting said investment history by use of a computer to display investment data.

10. The method of claim 7, further comprising reporting said investment history by use of a telephone to relay investment data.

11. The method of claim 1, further comprising branding said portfolio of entertainment creations.

12. The method of claim 3, wherein the step of assigning a rating further comprises conducting a survey of said entertainment creations to determine a trade volume.

13. The method of claim 12, wherein said trade volume is based on an average exchange trading day.

14. The method of claim 12, wherein said survey is conducted over the Internet.

15. The method of claim 12, further comprising conducting said survey by use of a computer to aggregate trade volume data.

16. The method of claim 12, further comprising conducting said survey by use of any one of a telephone, modem, or wireless technology to relay trade volume data.

17. The method of claim 12, wherein the step of conducting a survey further comprises determining an initial day's rating for said entertainment creation.

18. The method of claim 17, wherein the step of determining an initial day's rating is based on the first twenty-one (21) days that an entertainment creation is grouped into a portfolio.

19. The method of claim 3, wherein the step of assigning a rating further comprises providing an entertainment creation designer listing.

20. The method of claim 19, wherein the step of assigning a rating further comprises calculating an entertainment creation designer rating based on a percentage of times an entertainment creation designer is listed.

21. The method of claim 12, wherein the step of conducting a survey further comprises determining a production rating.

22. The method of claim 21, further comprising designating said production rating with a value when an entertainment creation matures from a first stage of development to a second subsequent state of development.

23. The method of claim 3, wherein the step of assigning a rating further comprises conducting a mock trading procedure over the Internet for said entertainment creation.

24. The method of claim 23, wherein said step of conducting a mock trading procedure generates a rating based on a number of times an entertainment creation is traded.

25. The method of claim 3, further comprising calculating ratings by use of a computer.

26. The method of claim 25, further comprising calculating said ratings by aggregating a database of rating inputs.

27. The method of claim 26, further comprising accessing said database of rating inputs via the Internet.

28. A system for establishing a product for investment in entertainment creations in early stages of development, the system comprising:
means for grouping entertainment creations in an early stage of development into a portfolio; and
means for investing in a portfolio.

29. The system of claim 28, further comprising a means for reporting a portfolio investment history.

30. The system of claim 28, further comprising means for rating an entertainment creation.

31. The system of claim 28, further comprising a means for branding a portfolio.

32. The system of claim 30, further comprising a computer system for grouping pilots into a portfolio based on a value generated by said means for rating.

33. The system of claim 28, wherein said means for grouping categorizes said entertainment creations according to whether a development organization has made a final decision as to whether to continue the development of said entertainment creations.

34. The system of claim 28, wherein said means for grouping categorizes said entertainment creations according to entertainment creation history.

35. The system of claim 28, further comprising a means for reporting an investment history of a portfolio.

36. The system of claim 28, further comprising a means for surveying of an entertainment creation to determine a trade volume.

37. The system of claim 36, wherein said means for surveying determines said trade volume based on an average exchange trading day.

38. The system of claim 36, wherein said means for surveying further comprises a means for determining an initial day's rating for said entertainment creation.

39. The system of claim 38, wherein said means for surveying determines said initial day's rating based on the first twenty-one days that an entertainment creation is grouped into a portfolio.

40. The system of claim 30, wherein said means for rating further comprises means for providing an entertainment creation designer listing.

41. The system of claim 40, wherein said means for rating a pilot calculates an entertainment creation designer rating based on a percentage of times an entertainment creation designer is listed.

42. The system of claim 36, wherein said means for surveying further comprises a means for determining a production rating.

43. The system of claim 42, wherein said means for determining a production rating designates said production rating with a value when an entertainment creation matures from a first stage of development to a second subsequent stage of development.

44. The system of claim 30, wherein said means for rating further comprises a means for conducting a mock trading procedure for said entertainment creation over the Internet.

45. The system of claim 44, wherein said means for conducting said mock trading procedure further comprises a computer system to access the Internet.

46. The system of claim 44, wherein said means for conducting said mock trading procedure generates a rating based on a number of times an entertainment creation is traded.

47. The system of claim 44, further comprising a database for aggregating ratings forming said portfolio.

48. The system of claim 47, further comprising a computer for accessing said database via the Internet.

49. The method of claim 1, wherein said entertainment creation comprises a creation selected from a group consisting of a television show, a video game, a theatre production, an opera, or a movie.

50. The system of claim 28, wherein said entertainment creation comprises a creation selected from a group consisting of a television show, a video game, a theatre production, an opera, or a movie.
